(19) United States
(12) Patent Application Publication
(10) Pub. No.: US 2023/0053132 A1
(43) Pub. Date: Feb. 16, 2023

(54) ARM-MOUNTED HANDS-FREE HAPTIC DISPLAY

(71) Applicant: TRITON SYSTEMS, INC., Chelmsford, MA (US)

(72) Inventors: James F. SAUNDERS, Lowell, MA (US); Tyson LAWRENCE, Highlands Ranch, CO (US); Kim HALLETT, Rochester, NH (US); Maciej PIETRUSINSKI, Reading, MA (US); Olivia CHONG, Somerville, MA (US); Marmaduke JD LOKE, Encinitas, CA (US); Max EVANS, Cambridge, MA (US)

(73) Assignee: TRITON SYSTEMS, INC., Chelmsford, MA (US)

(21) Appl. No.: 17/819,228

(22) Filed: Aug. 11, 2022

Related U.S. Application Data
(60) Provisional application No. 63/232,524, filed on Aug. 12, 2021.

(51) Int. Cl. G08B 6/00

(52) U.S. Cl. CPC G08B 6/00; H02K 7/003

(57) ABSTRACT

A haptic device includes a housing, a first motor configured to rotationally drive a first lead screw, a second motor configured to rotationally drive a second lead screw, and a touch point configured to contact the skin on a distal end. The rotation of the first lead screw is configured to move the touch point along a first axis and the rotation of the second lead screw is configured to move the touch point along a second axis The second axis can be perpendicular to the first axis. The haptic device can be configured to be worn on a user's arm via a wrist band or compression sleeve.

### RELATED APPLICATIONS

The present application claims priority to U.S. Provisional Patent Application No. 63/232,524, entitled “ARM-MOUNTED HANDS-FREE HAPTIC DISPLAY,” filed Aug. 12, 2021, which is hereby incorporated by reference herein in its entirety.

### GOVERNMENT INTEREST

This invention was made with Government support from the Department of the Army under Contract No./W81XWH-20-C-0008. The Government has certain rights in this invention.

### BACKGROUND

Traditional haptic devices convey virtual information about sensation at the fingertips. These devices can take the form of full or partial instrumented gloves, or instrumentation mounted directly onto individual fingers. The haptic devices apply forces, vibrations, or other mechanical stimuli to the fingertips of the user to convey the sensation of touch (e.g., during a VR session). The resulting devices encumber a user's hand which hinders effective use in a mixed-reality environment, where simulated haptic feedback is required when interacting with virtual objects, but the ability to handle and manipulate tools and other objects with unencumbered hands and/or fingertips is also desirable (e.g., in training of medical procedures).

An arm-mounted hands-free haptic display is needed that is both compact and quiet for ease of operation.

### SUMMARY

In some aspects, the techniques described herein relate to a haptic device including: a housing; a first motor configured to rotationally drive a first lead screw; a second motor configured to rotationally drive a second lead screw; and a touch point configured to contact the skin on a distal end; wherein a rotation of the first lead screw is configured to move the touch point along a first axis; wherein a rotation of the second lead screw is configured to move the touch point along a second axis perpendicular to the first axis; and wherein the haptic device is configured to be worn on a user's arm.

In some aspects, the techniques described herein relate to a haptic device, further including a compliant mechanism in contact with the touch point.

In some aspects, the techniques described herein relate to a haptic device, wherein the compliant mechanism passively maintains pressure between the touch point and the user's arm.

In some aspects, the techniques described herein relate to a haptic device, wherein the compliant mechanism is a compression spring.

In some aspects, the techniques described herein relate to a haptic device, further including an actuator interfaced to the compliant mechanism; wherein the actuator is configured to translate the compliant mechanism on a third axis; and wherein the compliant mechanism is in series between actuator and the touch point.

In some aspects, the techniques described herein relate to a haptic device, wherein the touch point further includes a rough surface on the distal end configured to prevent slippage on the user's arm.

In some aspects, the techniques described herein relate to a haptic device, wherein the first and second motor are DC stepper motors.

In some aspects, the techniques described herein relate to a haptic device, further including a control circuit, configured to control the first and second motors.

In some aspects, the techniques described herein relate to a haptic device, further including a control circuit, configured to control the first and second motors and the actuator.

In some aspects, the techniques described herein relate to a haptic device, further including a position sensor configured to measure a deflection of the compliant mechanism.

In some aspects, the techniques described herein relate to a haptic device, further including a wrist band interfaced to the housing;

In some aspects, the techniques described herein relate to a haptic device, further including a compression sleeve interfaced to the housing.

In some aspects, the techniques described herein relate to a haptic device, wherein the touch point is a metal shaft.

In some aspects, the techniques described herein relate to a haptic device, wherein the touch point is interfaced to the housing by a precision bushing.

In some aspects, the techniques described herein relate to a haptic device, further including a network communication interface.

In some aspects, the techniques described herein relate to a haptic device, further including: a first stage moveably interfaced to the first lead screw; and a second stage moveably interfaced to the second lead screw.

In some aspects, the techniques described herein relate to a haptic device, further including a first and second linear motion shaft configured to support at least one of the first or second stage with respect to the housing.

In some aspects, the techniques described herein relate to a haptic device, wherein the first linear motion shaft is mated to the housing with a hole and the second linear motion shaft is mated to the housing with a slot.

In some aspects, the techniques described herein relate to a haptic device, further including two racks and two associated pinion gears, wherein the two pinion gears are constrained in rotation by a shaft in torsion, and wherein the shaft is configured to maintain the alignment of at least one of the first or second stage with respect to the housing.

### BRIEF DESCRIPTION OF THE DRAWINGS

Aspects and embodiments of this application are depicted in the figures, wherein:

FIG. 1 depicts a haptic device in accordance with an embodiment.

FIG. 2 depicts another view of the haptic device of FIG. 1 in accordance with an embodiment.

FIG. 3 depicts a haptic device with a single circuit board in accordance with an embodiment.

FIG. 4 depicts a circuit board for controlling a haptic device in accordance with an embodiment.

FIG. 5A illustrates a base component of a housing sewn onto a compression sleeve in accordance with an embodiment.

FIG. 5B illustrates the remainder of the haptic device affixed onto the base of FIG. 5A in accordance with an embodiment

FIG. 6 illustrates the degrees of freedom of a haptic device with two motors and two lead screws in accordance with an embodiment.

FIGS. 7-9 illustrate multiple views of the components of a haptic device in accordance with an embodiment.

FIG. 10 illustrates a mechanical structure for minimizing friction along the guide shafts in accordance with an embodiment.

FIG. 11 illustrates a mechanical structure of maintaining alignment of a sliding stage in accordance with an embodiment

FIG. 12 illustrates another a mechanical structure of maintaining alignment of a sliding stage in accordance with an embodiment.

FIG. 13 depicts a block diagram of exemplary data processing system comprising internal hardware that may be used to contain or implement the various computer processes and systems as discussed above.

### DETAILED DESCRIPTION OF EMBODIMENTS

This disclosure is not limited to the particular systems, devices and methods described, as these may vary. The terminology used in the description is for the purpose of describing the particular versions or embodiments only and is not intended to limit the scope of the disclosure.

The following terms shall have, for the purposes of this application, the respective meanings set forth below. Unless otherwise defined, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention.

As used herein, the singular forms “a,” “an,” and “the” include plural references, unless the context clearly dictates otherwise. Thus, for example, reference to a “cell” is a reference to one or more cells and equivalents thereof known to those skilled in the art, and so forth.

As used herein, the term “about” means plus or minus 10% of the numerical value of the number with which it is being used. Therefore, about 50 mm means in the range of 45 mm to 55 mm.

As used herein, the term “consists of” or “consisting of” means that the device or method includes only the elements, steps, or ingredients specifically recited in the particular claimed embodiment or claim.

In embodiments or claims where the term “comprising” is used as the transition phrase, such embodiments can also be envisioned with replacement of the term “comprising” with the terms “consisting of” or “consisting essentially of.”

As will be understood by one skilled in the art, for any and all purposes, such as in terms of providing a written description, all ranges disclosed herein are intended as encompassing each intervening value between the upper and lower limit of that range and any other stated or intervening value in that stated range. All ranges disclosed herein also encompass any and all possible subranges and combinations of subranges thereof. Any listed range can be easily recognized as sufficiently describing and enabling the same range being broken down into at least equal halves, thirds, quarters, fifths, tenths, et cetera. As a non-limiting example, each range discussed herein can be readily broken down into a lower third, middle third and upper third, et cetera. As will also be understood by one skilled in the art, all language such as “up to,” “at least,” and the like include the number recited and refer to ranges that can be subsequently broken down into subranges as discussed above. Finally, as will be understood by one skilled in the art, a range includes each individual member. Thus, for example, a group having 1-3 components refers to groups having 1, 2, or 3 components as well as the range of values greater than or equal to 1 component and less than or equal to 3 components. Similarly, a group having 1-5 components refers to groups having 1, 2, 3, 4, or 5 components, as well as the range of values greater than or equal to 1 component and less than or equal to 5 components, and so forth.

In addition, even if a specific number is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, et cetera” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, et cetera). In those instances where a convention analogous to “at least one of A, B, or C, et cetera” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, et cetera). It will be further understood by those within the art that virtually any disjunctive word and/or phrase presenting two or more alternative terms, whether in the description, sample embodiments, or drawings, should be understood to contemplate the possibilities of including one of the terms, either of the terms, or both terms. For example, the phrase “A or B” will be understood to include the possibilities of “A” or “B” or “A and B.”

In addition, where features of the disclosure are described in terms of Markush groups, those skilled in the art will recognize that the disclosure is also thereby described in terms of any individual member or subgroup of members of the Markush group.

While the present disclosure has been illustrated by the description of exemplary embodiments thereof, and while the embodiments have been described in certain detail, the Applicant does not intend to restrict or in any way limit the scope of the appended claims to such detail. Additional advantages and modifications will readily appear to those skilled in the art. Therefore, the disclosure in its broader aspects is not limited to any of the specific details, representative devices and methods, and/or illustrative examples shown and described. Accordingly, departures may be made from such details without departing from the spirit or scope of the Applicant's general inventive concept.

A haptic device can provide a haptic cue by generating skin stretch through application of shear force. Skin stretch haptic cues may provide certain advantages over traditional position displacement haptic cues. In pneumatic systems, force output can be modulated relatively easily through pressure control. However, pneumatically actuated devices can be cumbersome due to the pressurized supply lines. Generating controllable shear forces, for the purpose of skin stretch, with electric actuators can increase the usability of the haptic device.

Alternatively, a haptic device can provide a haptic cue by generating a normal force on the surface of the user's arm.

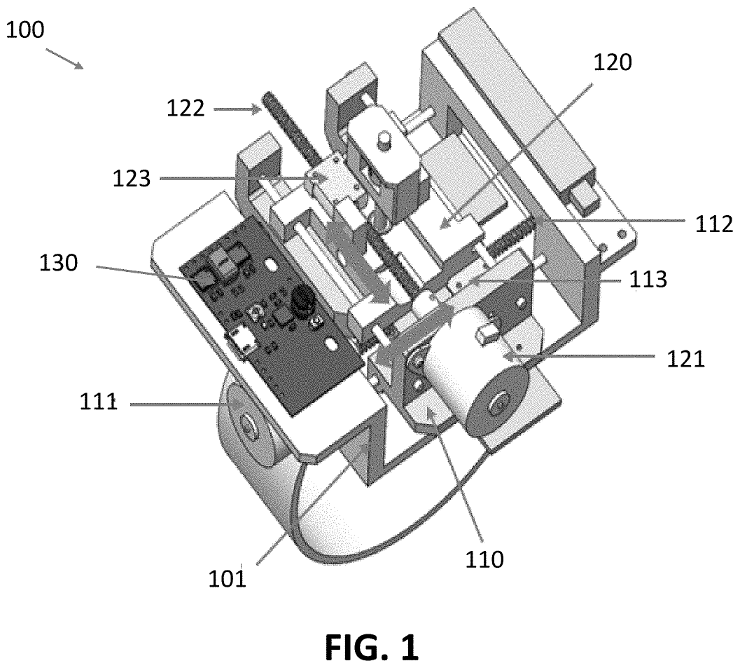

FIG. 1 depicts a haptic device 100 in accordance with an embodiment. The haptic device 100 can include a housing 101 for mounting any electrical or mechanical components associated with the haptic device 100. In some embodiments, the housing 101 can include a base for mounting the components. In further embodiments, the housing 101 can include walls and/or a lid for protecting the components.

The haptic device 100 can include one or more motors 111/121 for moving a touch point in relation to the wearer's skin. Two degrees of freedom (DOF) in the touch point can be sufficient for applying skin stretch. A first motor 111 can generate a first DOF in the touch point. The first motor 111 can produce rotational movement which can be translated into linear movement of the touch point through an interface to a first lead screw 112 and first lead nut 113. A second motor 121 can generate a second DOF in the touch point. The second motor 121 can produce rotational movement which can be translated into linear movement of the touch point through an interface to a second lead screw 122 and second lead nut 123. Each motor can be interfaced to a separate stage 110/120 to produce linear motion in an axis represented by the first lead screw 112 and an axis represented by the second lead screw 122. In some embodiments, the first lead screw 112 and second lead screw 122 can be perpendicular.

In some embodiments, backlash is limited because there is only one transmission stage. The transmission is not backdrivable, so unless the motor is executing a move, little energy is needed to maintain the position. The transmission ratio is large, so a compact and low torque motor can be used to generate significant forces.

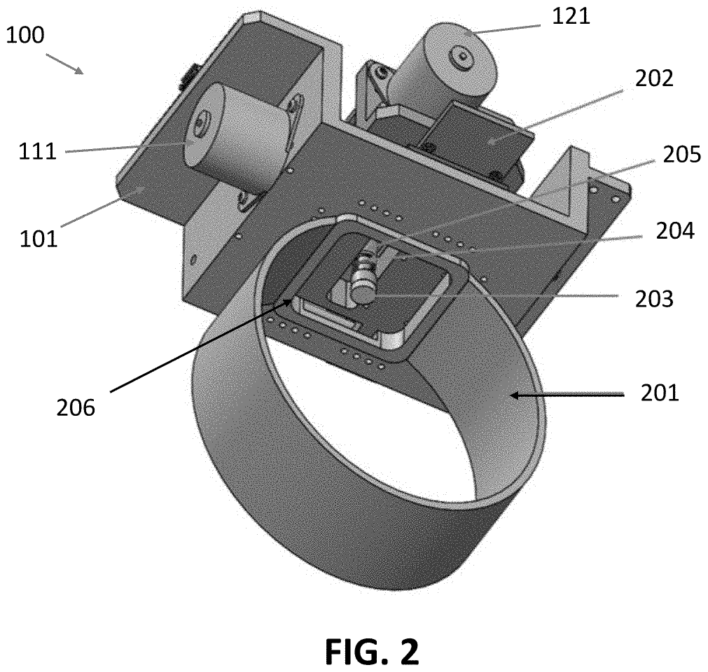

FIG. 2 depicts another view of the haptic device 100 in accordance with an embodiment. A wearable element 201 (e.g., wrist band or tight-fitting clothing piece) can be affixed to the housing 101 to allow a user to wear the device. In alternative embodiments, the haptic device 100 can be temporarily attached to an existing wearable element through an adhesive or pin. In some embodiments, the wearable element 201 can include a window 206 to allow the touch point to contact the wearer's skin. The window 206 can include a reinforced framed portion of the wearable element 201 or the window 206 can be formed by interfacing two portions of the wearable element 201 at separate locations on the housing 101.

The touch point can include a shaft extending through the window 206. The touch point can include a precision bearing 205 (e.g., a sleeve bearing) to allow for the motion of touch point in a third DOF (i.e., the direction of normal force on the wearer). The touch point can include a friction element 203 at the distal end. The friction element 203 can be configured to prevent the touch point from freely sliding in contact with the skin. The friction element 203 can comprise an abrasive material or a high friction material like rubber.

The touch point can include a compliant element 204 (e.g., a spring). In some embodiments, the compliant mechanism 204 can passively maintain contact between the touch point friction element 203 and the wearer's skin. The curvature and prominence of the wearer's anatomy (e.g., the arm surface) can easily change as a function of muscles' state (i.e., relaxed or flexed) and any resulting tendon tightness. A normal force can be generated on the changing surface using the compliant mechanism 204.

In an embodiment, the touch point is spring loaded. For example, a helical compression spring can press the touch point against the skin. As a result, the touch point can always be in contact with the skin. A large range of motion along the third DOF ensures contact over uneven body contour. The touch point can include a precision pin riding inside a precision sleeve bearing to minimize friction. The touch point can be manually raised and dis-engaged from contact with the skin for the purposes of resetting the device.

In other embodiments, the touch point is actuated through the compliant mechanism 204 to enable the application of dynamic normal force. The actuator can be placed either adjacent to the skin, or at the interface between the housing 101 and the actuator.

In some embodiments, elastic members (i.e., springs) can be placed in series with the motors 111/121, between the output of the linear actuation (i.e., the output of motor, screw, and nut combination) and their mounting. Deflection of the elastic member can be measured, and the associated forces can be calculated based on Hooke's Law. The calculated force feedback can be used in a force control scheme.

In another embodiment, the haptic device 100 can be configured to determine the linear forces generated from the first 111 and second 121 motors. The haptic cues can be mapped to the skin stretch force. The amount of skin stretch is a function of the skin's stiffness (i.e., tightness). In further embodiments, the normal force from the can be controlled by changing the position of the proximal end of the compliant mechanism 204 to modulate the force in the compliant mechanism 204 as applied as the normal force between the touch point and skin. Normal force feedback can be computed by measuring the deflection of the compliant mechanism 204 and calculating using Hooke's Law.

In some embodiments, the haptic device 100 can include a linear encoder 202 configured to measure the relative motion between the housing 101 and the first stage 110. A second linear encoder can be used to measure the relative motion between the housing 101 and the second stage 120. In other embodiments, any known means of determining the motion of the stage 110/120 can be used, such as measuring the rotation of the motor (e.g., through a Hall effect sensor).

A normal force is applied to the wearer through the touch point, as described herein. The touchpoint can be mounted such that any friction or resistance to motion in the normal (i.e., vertical) direction is minimized, while constraining other DOFs. In some embodiments, rotation may also not be constrained. In some embodiments, actuated control of normal force includes mounting a compliant mechanism 204 in series between the touchpoint and the actuator, such that any motion or force exerted by the actuator onto the touch point passes through the complaint mechanism 204 to the wearer. The actuator can be a DC motor. The actuator can operate under position control (e.g., closed loop control) or it can operate under open loop control, and the displacement of the actuator can result in a combined deflection of the in-series compliant mechanism 204 and the underlying tissue. In another embodiment, the in-series complaint mechanism 204 further includes a position sensor which measures the deflection of the compliant mechanism 204. The control scheme can use the spring deflection as the feedback signal in a closed loop force control scheme to closely control the deflection of the complaint mechanism 204, irrespective of the displacement of either the touch point or the actuator itself. The actuator operates either under current control (i.e., current consumption is approximately linearly related to the motor's torque output), or it operates under position control (i.e., position feedback is a measured deflection of the compliant mechanism 204).

In some embodiments, the touchpoint element that presses down on the wrist, and an actuator could rotate the touchpoint and cause the skin to twist. This could be useful for conveying haptic feedback associated with turning knobs, for example. This could be the sole active degree of freedom (DoF) on the wrist-worn, or it could be an additional active DoF on a wrist worn that already features skin stretch in one direction or more.

As part of a larger training, simulation, and/or navigational system, the haptic device receives commands over a communication interface (e.g., Bluetooth®, WiFi, Ethernet, Universal Serial Bus, etc.) to stretch the skin of the user and/or apply normal force (i.e., pressing into the skin) to generate haptic cues. These haptic cues may be generated by an external mapping algorithm in order to convey physical characteristics of a virtual object that the user is interacting with, or the external mapping algorithm may generate haptic cues for other purposes, such as guidance. As an example, a skin stretch can indicate the direction of hand motion to be executed. In another example, the skin stretch can simulate an opposing force to an undesirable movement. In an embodiment the device receives position commands, based on a mapping of haptic feedback to skin stretch amount. In some embodiments, the skin stretch amount can be measured in millimeters.

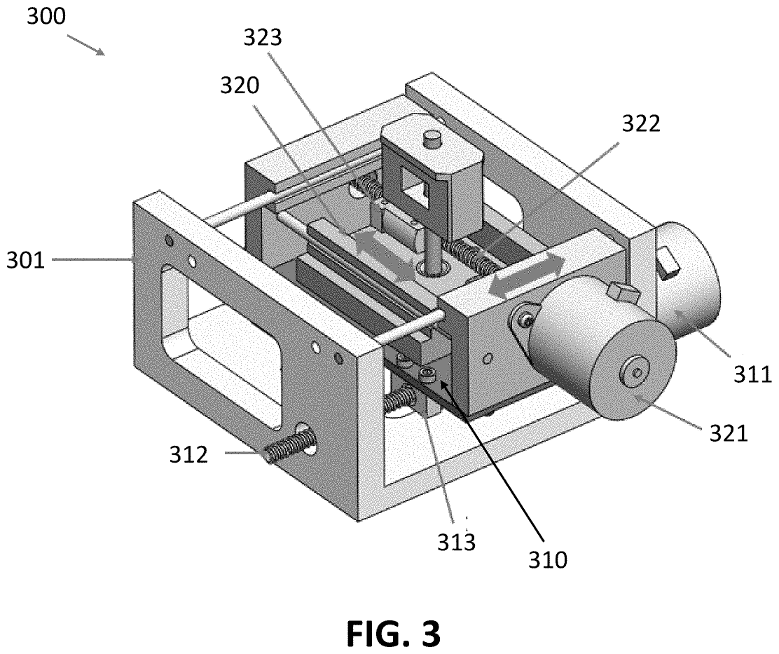

FIG. 3 depicts a haptic device with a single circuit board in accordance with an embodiment. Although some embodiments, may employ more than one circuit board, using a single circuit board allows it to double as a structural element. The haptic device 300 can include a housing 301 for mounting any electrical or mechanical components associated with the haptic device 300. In some embodiments, the housing 301 can include a base for mounting the components. In further embodiments, the housing 301 can include walls and/or a lid for protecting the components.

The haptic device 300 can include one or more motors 311/321 for moving a touch point in relation to the wearer's skin. Two degrees of freedom (DOF) in the touch point can be sufficient for applying skin stretch. A first motor 311 can generate a first DOF in the touch point. The first motor 311 can produce rotational movement which can be translated into linear movement of the touch point through an interface to a first lead screw 312 and first lead nut 313. A second motor 321 can generate a second DOF in the touch point. The second motor 321 can produce rotational movement which can be translated into linear movement of the touch point through an interface to a second lead screw 322 and second lead nut 323. Each motor can be interfaced to a separate stage 310/320 to produce linear motion in an axis represented by the first lead screw 312 and an axis represented by the second lead screw 322. In some embodiments, the first lead screw 312 and second lead screw 322 can be perpendicular.

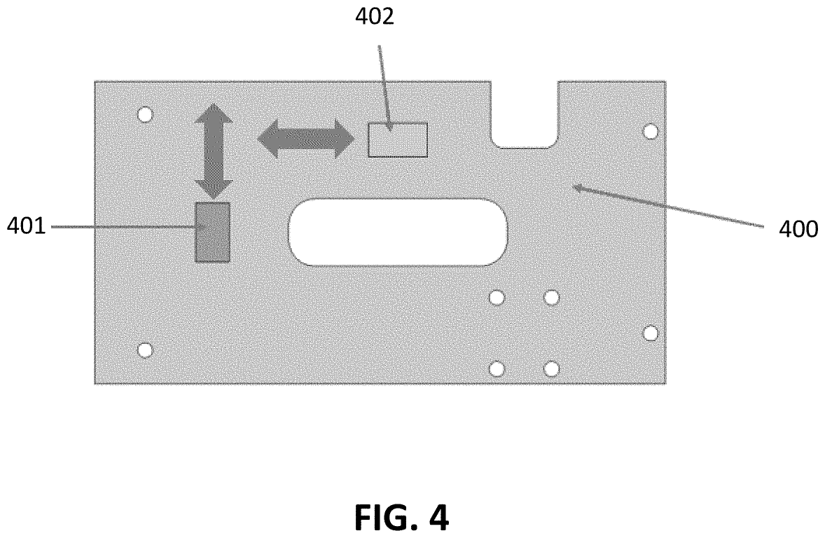

The first stage 310 may comprise a printed circuit board (PCB). FIG. 4 depicts a PCB 400 for controlling a haptic device in accordance with an embodiment. Two linear position encoders 401/402 (i.e., position sensors) can be placed on the PCB 400. The PCB 400 can further contain all of or a majority of the electronic components required for communication, actuation and sensing for the haptic device 300. As the PCB 400 defines integral part of the structure of the first stage 310, the PCB 400 is adjacent to both the housing 301 and the second stage 320. As a result, it can be possible to measure relative motion between the housing 301, first stage 301, and second stage 320 using the linear position encoders 401 402. In some embodiments, each linear encoder can be configured to measure linear movement along an axis of a lead screw 312/322. FIG. 4 also demonstrates it is possible to fit all functions onto one circuit board, which is possible when the board is located on either one of the two moving ‘slides’ or ‘stages’.

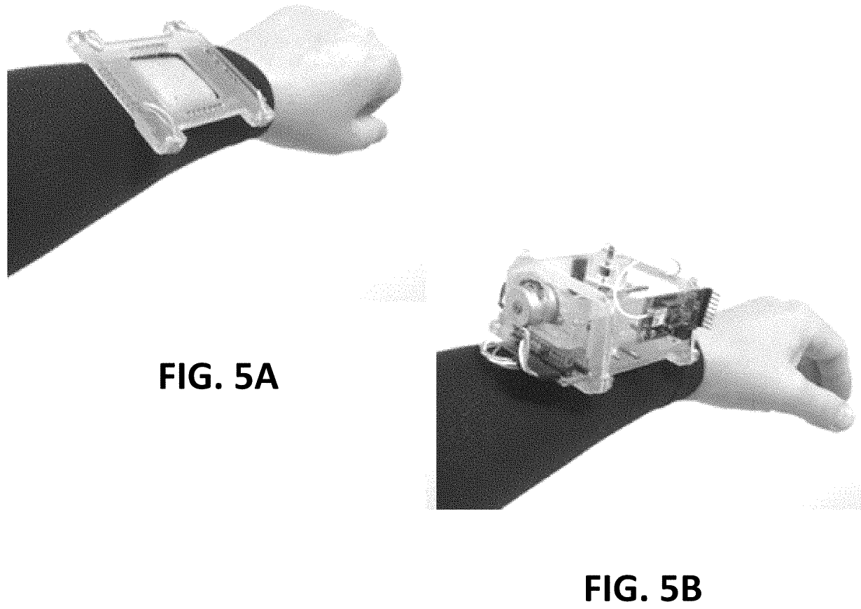

FIGS. 5A and 5B illustrate an example method of securing the haptic device to a wearer in accordance with an embodiment. The haptic device can be easily and securely donned by utilizing a compression sleeve on the forearm. The modified compression sleeve can have a cutout over the area manipulated by the haptic device. FIG. 5A illustrates a base component of a housing sewn onto the sleeve. FIG. 5B illustrates the remainder of the haptic device affixed onto the base. The base and the remainder of the haptic device can be secured by any number of methods, including, but not limited to thumb screws, magnets, elastic bands, or metal springs.

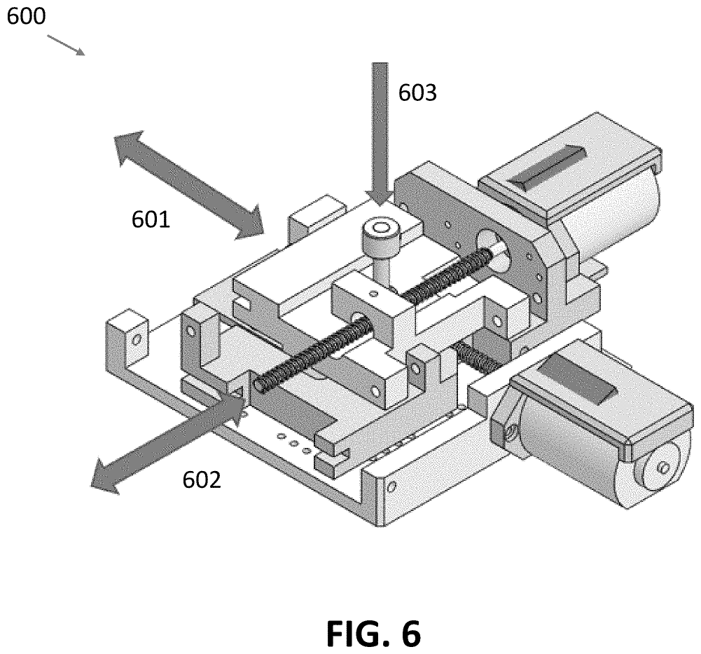

The haptic device can utilize miniature rotary motors to generate motion. Such miniature motors are generally characterized by high speed but low torque. Yet with a single stage screw mechanism each motor can achieve relatively high force output (e.g., several newtons), with little audible noise and with high efficiency. FIG. 6 illustrates the DOF of a haptic device 600 with two motors and two lead screws in accordance with an embodiment. A first DOF 601 can provide linear movement along an ‘x’ axis based on the operation of the first motor and lead screw. A second DOF 602 can provide linear movement along an ‘y’ axis based on the operation of the second motor and lead screw. The passive and/or active movement of the touch point can provide a third DOF 603, linear movement along a ‘z’ axis. In some embodiments, the touch point may additionally be configured to rotate. The touch point can be a streel shaft. The touch point can be riding in a precision bushing (e.g., a sleeve bearing), resulting in low mechanical play and low friction.

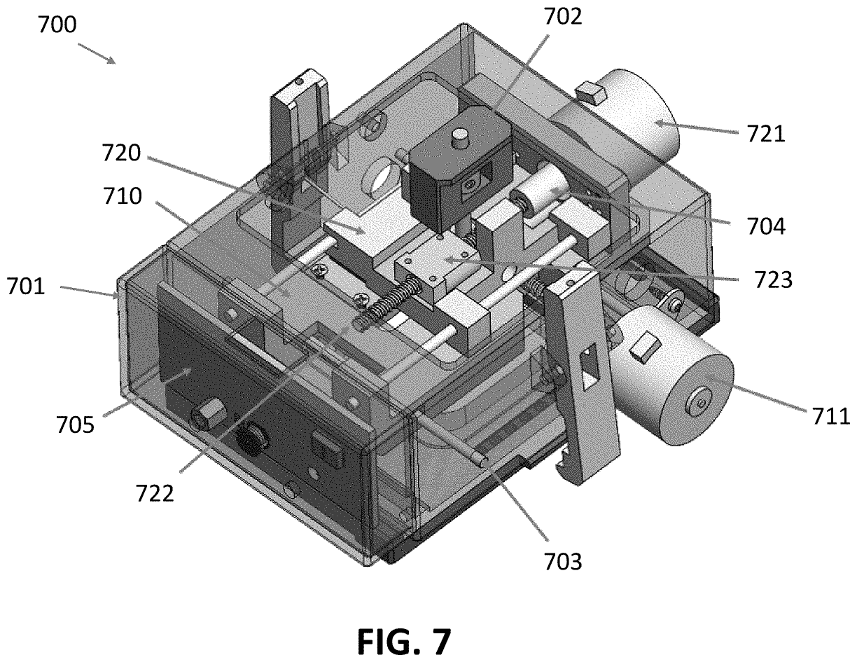

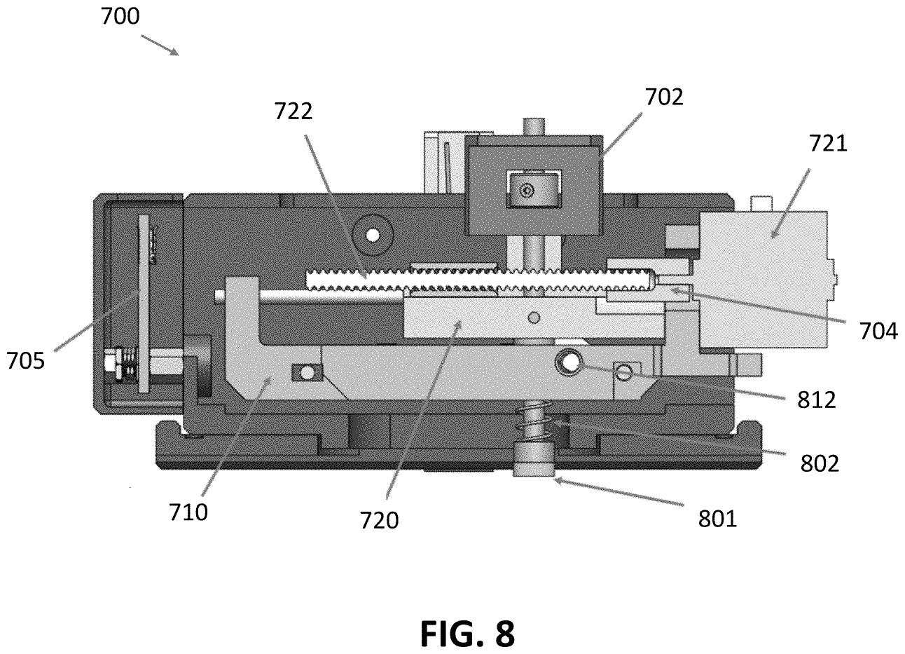

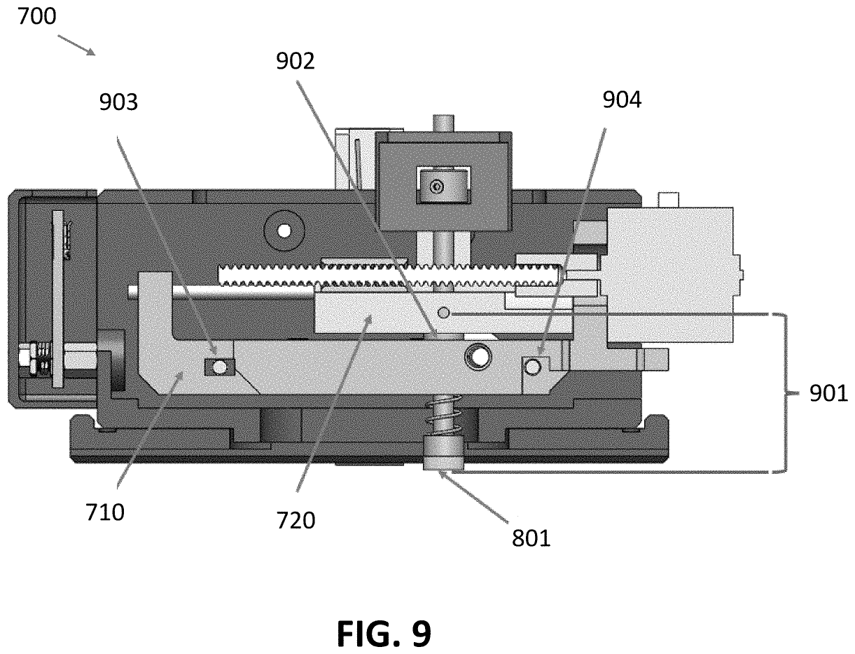

FIGS. 7-9 illustrate multiple views of the components of a haptic device 700 in accordance with an embodiment. The haptic device 700 can include one or more stepper motors 711/721 for moving a touch point 801 in relation to the wearer's skin. A first motor 711 can generate a first DOF in the touch point 801. The first motor 711 can produce rotational movement which can be translated into linear movement of the touch point through an interface to a first lead screw 812 and first lead nut. The first lead screw 812 can be interfaced to the first motor 711 through a shaft adapter. A second motor 721 can generate a second DOF in the touch point. The second motor 721 can produce rotational movement which can be translated into linear movement of the touch point through an interface to a second lead screw 722 and second lead nut 723. The second lead screw 722 can be interfaced to the second motor 721 through a shaft adapter 704. Each motor can be interfaced to a separate stage 710/720 to produce linear motion in an axis represented by the first lead screw and an axis represented by the second lead screw 722. The first stage 710 can be moveably affixed to the housing 701 by a linear motion shaft perpendicular to the first lead screw. The second stage 720 can be moveably affixed to the housing 701 by a linear motion shaft 703 perpendicular to the second lead screw 722. In some embodiments, the first lead screw 812 and second lead screw 722 can be perpendicular.

The touch point 801 can passively provide a normal force through the tension of a compliant mechanism 802 (e.g., a spring) and/or actively through a touch point handle 702. In some embodiments, the touch point handle 702 is manual. In other embodiments, the touch point handle 702 is interfaced to a third actuator. The third actuator can be a stepper motor. Movement of the touch point 801 can be facilitated by a precision bearing 902.

The two stages 710/720 of the device can be constrained to move in only one DOF each. Each stage slides along the two linear motion shafts 903/904. To avoid over-constraining, a first linear shaft 904 can be mated with a through hole in the stage 710, while the other linear motion shaft can be mated with a slot 903.

The main motion components in the assembly can be arranged to minimize friction along the touch point shaft, and to minimize friction along the guide shafts 903/904. Minimizing friction along the touch point shaft can be achieved through minimization of the vertical distance 901 between the tip of the touch point 801 and the location of the precision bearing 902. Minimizing this distance 901 reduces the moment that must be resolved by the precision bearing 902. The moment at the precision bearing 902 is directly proportional to sliding friction which could prevent the touch point 801 from floating and following the contours of the underlying body.

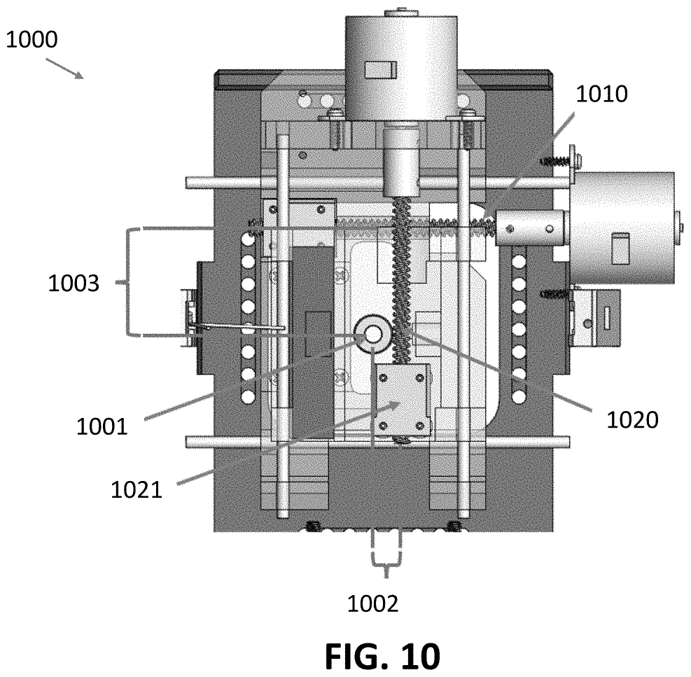

Referring briefly to FIG. 10, minimizing friction along the guide shafts 903/904 can be achieved by minimizing the distance 1002/1003 between the line of action of the thrust force coming from the linear actuators (i.e., the lead screw 1010/1020 driven by the motor) and the touch point 1001. In the depicted example, for the first actuator and first lead screw 1010, the line of action 1002 can be positioned very close to the touch point 1001. For the second actuator and second lead screw 1020 the moment arm 1003 must be larger to allow for the range of motion of the second stage.

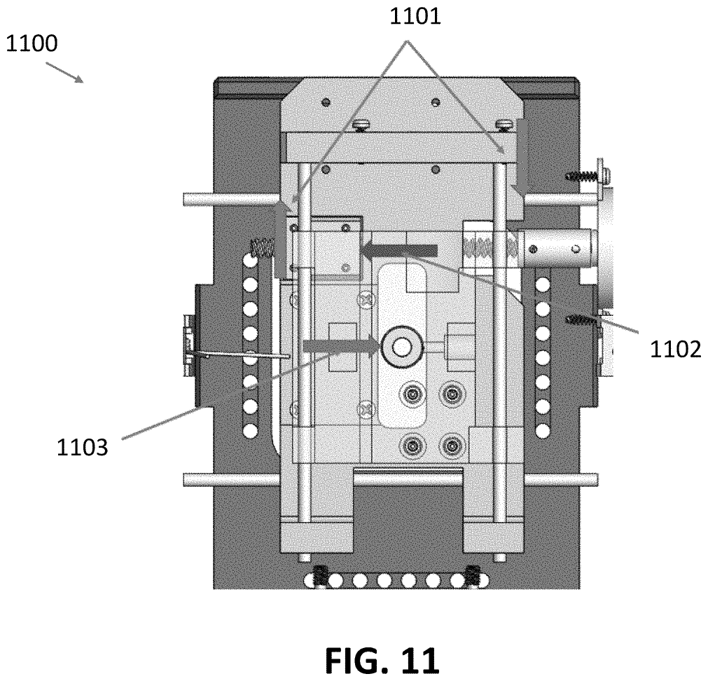

Referring briefly to FIG. 11, the resulting larger moment 1003 arm results in a moment 1101 acting to rotate the first stage out of alignment. The actuator lead screw thrust exerts force 1102 onto the carriage at the first stage, causing motion. The resulting skin stretch generates a reactionary force 1103. With the opposing forces' lines of action separated by some distance, a moment 1101 is generated, which must be resolved at one of the linear motion shafts that the stage rides on. The greater the width of the stage, the lower the force between the stage and the linear motion shaft, thus a lower friction. The overall size of the device can be minimized, while maximizing the distance between the resolving forces at the linear slide shaft interface, to minimize friction.

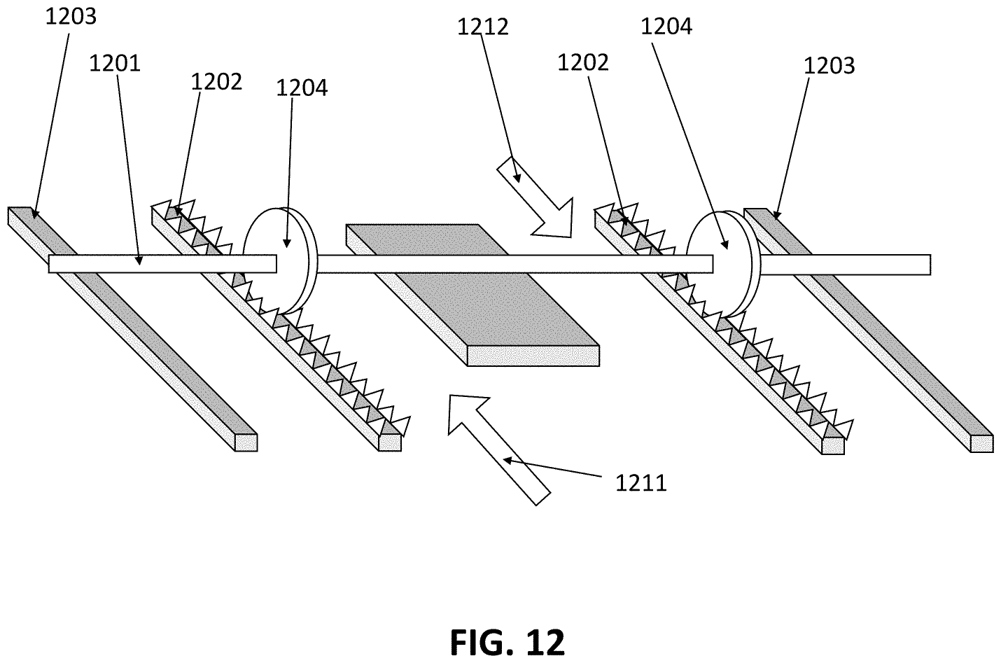

FIG. 12 illustrates another method of maintaining alignment of a sliding element. When a thrust load line of action 1211 is offset from the reaction force 1212, a two rack-and-pinion setup with the two pinion gears 1204 constrained in rotation by a shaft 1201, in torsion, can be employed. Dual rack-pinion mechanism keeps a linear slide tracking straight and prevents misalignment, even when the thrust force 1211 and the reaction force 1212 are offset. The method generates less friction than a linear shaft setup where offset forces can generate normal forces at the bearing surfaces, leading to higher friction. Rails 1203 can be provided on either side to keep the pinions 1204 engaged with the gear racks 1202.

Though the example haptic devices, described herein, refer to attachment on the wrist or forearm, a similar device can be used for applying haptic cues to other portions of the body.

### Example Computer System

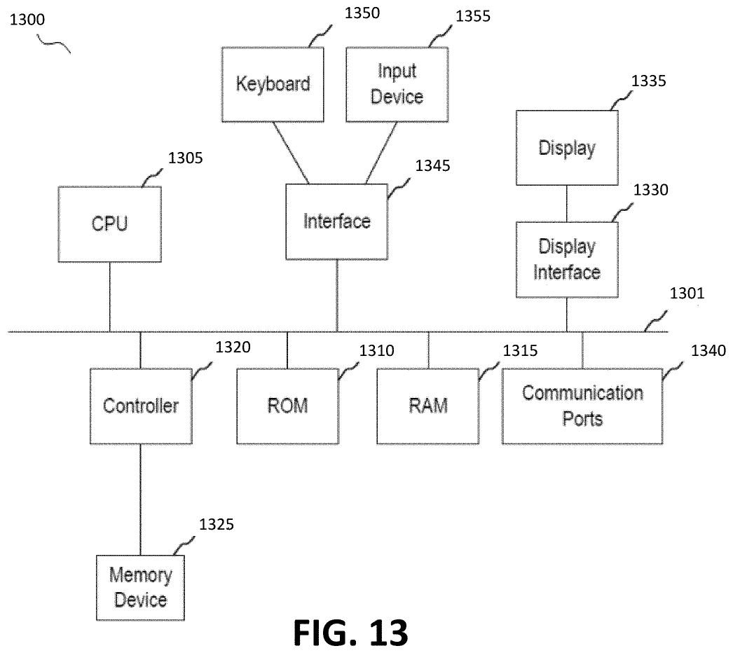

FIG. 13 depicts a block diagram of exemplary data processing system 1300 comprising internal hardware that may be used to contain or implement the various computer processes and systems as discussed above. In some embodiments, the exemplary internal hardware may include or may be formed as part of a database control system. In some embodiments, the exemplary internal hardware may include or may be formed as part of an additive manufacturing control system, such as a three-dimensional printing system. A bus 1301 serves as the main information highway interconnecting the other illustrated components of the hardware. CPU 1305 is the central processing unit of the system, performing calculations and logic operations required to execute a program. CPU 1305 is an exemplary processing device, computing device or processor as such terms are used within this disclosure. Read only memory (ROM) 1310 and random access memory (RAM) 1315 constitute exemplary memory devices.

A controller 1320 interfaces with one or more optional memory devices 1325 via the system bus 1301. These memory devices 1325 may include, for example, an external or internal DVD drive, a CD ROM drive, a hard drive, flash memory, a USB drive or the like. As indicated previously, these various drives and controllers are optional devices. Additionally, the memory devices 1325 may be configured to include individual files for storing any software modules or instructions, data, common files, or one or more databases for storing data.

Program instructions, software or interactive modules for performing any of the functional steps described above may be stored in the ROM 1310 and/or the RAM 1315. Optionally, the program instructions may be stored on a tangible computer-readable medium such as a compact disk, a digital disk, flash memory, a memory card, a USB drive, an optical disc storage medium, such as a Blu-Ray™ disc, and/or other recording medium.

An optional display interface 1330 can permit information from the bus 1301 to be displayed on the display 1335 in audio, visual, graphic or alphanumeric format. Communication with external devices can occur using various communication ports 1340. An exemplary communication port 1340 can be attached to a communications network, such as the Internet or a local area network.

The hardware can also include an interface 1345 which allows for receipt of data from input devices such as a keyboard 1350 or other input device 1355 such as a mouse, a joystick, a touch screen, a remote control, a pointing device, a video input device and/or an audio input device.

In the above detailed description, reference is made to the accompanying drawings, which form a part hereof. In the drawings, similar symbols typically identify similar components, unless context dictates otherwise. The illustrative embodiments described in the present disclosure are not meant to be limiting. Other embodiments may be used, and other changes may be made, without departing from the spirit or scope of the subject matter presented herein. It will be readily understood that various features of the present disclosure, as generally described herein, and illustrated in the Figures, can be arranged, substituted, combined, separated, and designed in a wide variety of different configurations, all of which are explicitly contemplated herein.

The present disclosure is not to be limited in terms of the particular embodiments described in this application, which are intended as illustrations of various features. Instead, this application is intended to cover any variations, uses, or adaptations of the present teachings and use its general principles. Further, this application is intended to cover such departures from the present disclosure as come within known or customary practice in the art to which these teachings pertain. Many modifications and variations can be made to the particular embodiments described without departing from the spirit and scope of the present disclosure as will be apparent to those skilled in the art. Functionally equivalent methods and apparatuses within the scope of the disclosure, in addition to those enumerated herein, will be apparent to those skilled in the art from the foregoing descriptions. It is to be understood that this disclosure is not limited to particular methods, reagents, compounds, compositions or biological systems, which can, of course, vary. It is also to be understood that the terminology used herein is for the purpose of describing particular embodiments only and is not intended to be limiting.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

What is claimed is:

1. A haptic device comprising:
a housing;
a first motor configured to rotationally drive a first lead screw;
a second motor configured to rotationally drive a second lead screw; and
a touch point configured to contact the skin on a distal end;
wherein a rotation of the first lead screw is configured to move the touch point along a first axis;
wherein a rotation of the second lead screw is configured to move the touch point along a second axis perpendicular to the first axis; and
wherein the haptic device is configured to be worn on a user's arm.

2. The haptic device of claim 1, further comprising a compliant mechanism in contact with the touch point.

3. The haptic device of claim 2, wherein the compliant mechanism passively maintains pressure between the touch point and the user's arm.

4. The haptic device of claim 2, wherein the compliant mechanism is a compression spring.

5. The haptic device of claim 2, further comprising an actuator interfaced to the compliant mechanism;
wherein the actuator is configured to translate the compliant mechanism on a third axis; and
wherein the compliant mechanism is in series between actuator and the touch point.

6. The haptic device of claim 1, wherein the touch point further comprises a rough surface on the distal end configured to prevent slippage on the user's arm.

7. The haptic device of claim 1, wherein the first and second motor are DC stepper motors.

8. The haptic device of claim 1, further comprising a control circuit, configured to control the first and second motors.

9. The haptic device of claim 5, further comprising a control circuit, configured to control the first and second motors and the actuator.

10. The haptic device of claim 5, further comprising a position sensor configured to measure a deflection of the compliant mechanism.

11. The haptic device of claim 1, further comprising a wrist band interfaced to the housing;

12. The haptic device of claim 1, further comprising a compression sleeve interfaced to the housing.

13. The haptic device of claim 1, wherein the touch point is a metal shaft.

14. The haptic device of claim 1, wherein the touch point is interfaced to the housing by a precision bushing.

15. The haptic device of claim 1, further comprising a network communication interface.

16. The haptic device of claim 1, further comprising:
a first stage moveably interfaced to the first lead screw; and
a second stage moveably interfaced to the second lead screw.

17. The haptic device of claim 16, further comprising a first and second linear motion shaft configured to support at least one of the first or second stage with respect to the housing.

18. The haptic device of claim 17, wherein the first linear motion shaft is mated to the housing with a hole and the second linear motion shaft is mated to the housing with a slot.

19. The haptic device of claim 16, further comprising two racks and two associated pinion gears, wherein the two pinion gears are constrained in rotation by a shaft in torsion, and wherein the shaft is configured to maintain the alignment of at least one of the first or second stage with respect to the housing.
